(19) United States
(12) Patent Application Publication
(10) Pub. No.: US 2006/0250327 A1
(43) Pub. Date: Nov. 9, 2006

(54) Energy recovery device for plasma display panel

(75) Inventors: Fransiscus Jacobus Vossen, Eindhoven (NL); Sander Derksen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/554,527

(22) PCT Filed: Apr. 27, 2004
(86) PCT No.: PCT/IB04/50522

§ 371 Date: Oct. 26, 2005

(30) Foreign Application Priority Data
Apr. 29, 2003 (EP) 03101171.1

(51) Int. Cl. G09G 3/28

(52) U.S. Cl. 345/60

(57) ABSTRACT

Disclosed is an energy recovery device for recovering energy in a display panel, in particular a plasma display panel, wherein an energy recovery storing unit (L_{recover}) is coupled with the display panel during an energy recovery period following a sustain period. The particularity of the invention is that the energy recovery recover storing unit (L_{recover}) is charged in said sustain step.

### FIELD OF THE INVENTION

The present invention relates to an energy recovering sustain device for a display panel, in particular a plasma display panel (PDP), comprising an energy recovery storing means adapted for coupling with the display panel for performing an energy recovery period following a sustain period.

Further, the present invention relates to a driving apparatus for driving a display panel, in particular a plasma display panel (PDP), comprising the mentioned energy recovery sustain device. Still further, the present invention relates a display apparatus for displaying an image, comprising a display panel, in particular plasma display panel (PDP), and such an energy recovery sustain device.

### BACKGROUND OF THE INVENTION

In recent years, a thin display apparatus has been requested in conjunction with an increase in size of the display panel. The plasma display panel (hereinafter simply referred to as “PDP”) is expected to become one of the most important display devices of the next generation which replaces the conventional cathode ray tube, because the PDP can easily realize reduction of thickness and weight of the panel and the provision of a flat screen shape and a large screen surface.

In the PDP, which makes a surface discharge, a pair of electrodes is formed on an inner surface of a front glass substrate and a rare gas is filled within the panel. When a voltage is applied across the electrodes, a surface discharge occurs at the surface of a protection layer and a dielectric layer formed on the electrode surface, thereby generating ultraviolet rays. Fluorescent materials of the three primary colors red, green and blue are coated on an inner surface of a back glass substrate, and a color display is made by exciting the light emission from the fluorescent materials responsive to the ultraviolet rays.

The PDP comprises a plurality of column electrodes (address electrodes) and a plurality of row electrodes arranged so as to intersect the column electrodes. Each of the row electrodes pairs and the column electrodes are covered by a electric layer against a discharge space and have a structure such that a discharge cell corresponding to one pixel is formed at an intersecting point of the row electrode pair and the column electrode. Since the PDP provides a light emission display by using a discharge phenomenon, each of the discharge cells has only two states, a state where the light emission is performed and a state where it is not performed.

The discharge is achieved by adjusting voltages between the column and row electrodes of a cell composing a pixel. The amount of discharged light changes to adjust the number of discharges in the cell. The overall screen is obtained by driving in a matrix type a write pulse for inputting a digital video signal to the column and row electrodes of the respective cells, a scan pulse for scanning a sustain pulse for sustaining discharge, and an erase pulse for terminating discharge of a discharged cell.

So, in a PDP, different phases in time are used to create (moving) pictures. In general, there are three phases, namely an erase/setup phase for erasing the complete display panel, a programming/addressing phase for programming the picture to be displayed, and a sustain phase for showing the picture on the display panel. For displaying real time video on a PDP, a subfield is build up by the erase phase, the address phase and the sustain phase. In the sustain phase, actual light is generated by the PDP, and the PDP is driven with relatively high voltages and consequently large high frequent current peaks are involved. As far as circuit costs and EMI (electromagnetic interference) are concerned, the most is concentrated in the sustain phase.

Because of the mainly capacitive character of the display panel, with a proper energy recovery sustain circuit, blind power dissipation can be strongly reduced. Such an energy recovery sustain circuit is usually based on a circuit, in which an external inductor forms a resonant loop with the panel capacitance.

It has been suggested an energy recovery sustain circuit to drive a PDP (see Weber, L. F. and M. B. Wood, “Energy Recovery Sustain Circuit for the AC Plasma Display”, SID 87 Digest, pp. 92-95, 1987). In such energy recovery sustain circuit, in parallel with a full bridge driver circuitry an extra circuitry is placed by which the stored energy in the panel capacitance is recovered. A principle schematic of the topology the recover energy called Weber topology is shown in FIG. 1.

In the Weber topology, the display panel which is shown as its capacitance Cₚₐₙₑₗ in FIG. 1 is connected via switch c₁ to the sustain voltage source Vₛᵤₛₜₐᵢₙ and via switch c₂ to ground at the common side CS and via switch s₁ to a sustain voltage source Vₛᵤₛₜₐᵢₙ and via switch s₂ to ground at the scan-side SS. Further, the display panel is connected via switches e₁ and e₂ to a first energy recovery inductor L_{recover} at the common side and via switches e3 and e4 to a second energy recovery inductor L_{recover} at the scan-side. Both the energy recovery inductors L_{recover} are each connected to a buffer capacitor C_{buffer}, which again is coupled to ground. So, at each side of the display panel, i.e. at the scan-side and at the common side, an energy recovery inductor L_{recover} is provided so that two energy recovery inductors L_{recover} are used.

The buffer capacitors C_{buffer} are provided to store energy which is re-used in a next sustain period. With energy recovery, the voltage over the panel is inverted in two sequential steps. These steps are shown in FIGS. 2a to 2d, and the corresponding current flows and voltage swings in this circuit are shown in FIG. 2e.

The first sustain pulse is given to the scan-side of the panel. This is shown in FIG. 2a. By activating (closing) switches s₁ and c₂, plasma cells in the PDP ignites and a light pulse is emitted. Corresponding with a light pulse, quite a high current peak flows through the panel.

In FIG. 2b, where switch s₁ is de-activated (opened), but switch c₂ remains activated, the scan-side of the panel capacitance Cₚₐₙₑₗ is discharged and stored in the buffer capacitor C_{buffer} provided at this side of PDP. Subsequently the common-side of the Cₚₐₙₑₗ capacitance panel is charged by the buffer capacitor C_{buffer} at this side of the PDP, wherein switch c₂ is de-activated (opened) and switch s₂ is activated (closed) (FIG. 2c).

After this resonant cycle is over, the common-side is sustained by activating switches c₁ and s₂ (FIG. 2d). In the second halve of the sustain period, the energy in the panel capacitance is discharged and charged again the other way around. Charge is transferred from panel capacitance Cₚₐₙₑₗ to buffer capacitors C_{buffer} and vice versa.

For proper operation of the circuit, quite large buffer capacitors are required. If this is the case, the voltage rise and fall (discharging and charging the panel capacitance Cₚₐₙₑₗ) over the buffer capacitors C_{buffer} will be negligible and stabilizes at half the sustain voltage.

A further conventional but more straightforward method to recover stored energy in the panel capacitance of a PDP is taught by U.S. Pat. No. 5,670,974 A. A principle schematic of this topology called Ohba topology is shown in FIG. 3. A big difference from the above-described Weber topology is the absence of buffer capacitors. A further difference from the above described Weber topology is that only one energy recovery inductor L_{recover} is used which is connected via switches e₁ and e₂ in parallel with the display panel. So, charge in the panel capacitance Cₚₐₙₑₗ is not stored in buffer capacitors, but directly recovered with the energy recovery inductor L_{recover} connected in parallel with the panel capacitance Cₚₐₙₑₗ. The operation of this topology is shown in FIGS. 4a to 4c, and the corresponding current flows and voltage swings in this circuit are shown in FIG. 4d.

By activating (closing) the switches s₁ and c₂ in FIG. 4a, the panel capacitance Cₚₐₙₑₗ is charged to the sustain voltage. When s₁ and c₂ are de-activated (opened), the panel capacitance Cₚₐₙₑₗ is floating while the charge in the panel capacitance Cₚₐₙₑₗ remains. By closing switch e₂ (FIG. 4b) an inductor L_{recover} is connected in series with the panel capacitance Cₚₐₙₑₗ. A sine-wave current starts to flow, and over the panel capacitance Cₚₐₙₑₗ a cosine shaped voltage is present (cf. FIG. 4d).

The flowing current and the panel voltage during energy recovery are shown next to FIG. 4b. This topology makes use of a half-period of the resonance phenomenon. When half a sine wave is completed, the current Irecover passes a zero crossing. By inserting a diode in the resonance loop, the current Irecover is prohibited to go negative (FIG. 4d). As this point, the voltage over the panel capacitance Cₚₐₙₑₗ has reversed maximal and, since the current is blocked, this voltage level remains constant. Switch e₂ can be de-activated, by which the energy recovery cycle is over. With switches c₁ and s₂ being activated (in FIG. 4c), inevitable losses in the resonant path are compensated and a proper sustain pulse is reached.

At this moment, halve of a sustain period is completed. The second halve is very much similar to the first halve, but now energy is recovered the other way around. After doing so, again the scan-side of the PDP may be sustained again as shown in FIG. 4a.

The erase phase and the address phase are identical with those of the above-described Weber topology.

U.S. Pat. No. 5,642,018 A discloses an energy driver circuit for driving a display panel having panel electrodes and panel capacitance. This known circuit includes an inductor means coupled to the panel electrodes, a driving voltage source, a voltage supply for providing a supply voltage of a magnitude which is greater than the driving voltage, and a first switch device for selectively coupling the driving voltage to the inductor in response to a rising input signal transition. The input signal transition commences a first state, wherein a first current flow occurs through the inductor to charge the panel capacitance. The inductor causes the panel electrodes to rise to a voltage in excess of the driving voltage, at which point the first current flow reaches zero. A second switch device is provided for selectively coupling the voltage supply to the inductor and panel electrodes. A switch control is responsive to current flow in the inductor and is operative during the first state to initially maintain the second switch device in an open condition, and thereafter, in response to signals derived from the inductor, to cause a closure of the second switch device at a time which enables said second switch device to be fully conductive when the first current flow reaches zero, whereby the supply voltage source during a succeeding second state supplies current to both the panel electrodes and flyback current to said inductor. A like circuit is similarly operational on a falling input signal transition.

JP 10 26 88 31 A shows an electric power recovering circuit for a plasma display panel. In this known circuit, a RC circuit composted of a capacitor and a resister is connected in parallel to a power recovering coil for outputting a voltage from an electric power recovering capacitor, whereby a spike voltage generated in the power recovering coil is effectively absorbed and a high voltage and a high frequency current is transiently prevented from being generated. So, the oscillations are damped which, however, dissipates energy. Further, some voltage steps still occur at least during hard switching.

US 2002/0047577 A1 discloses an energy recovery sustain circuit for an AC plasma display panel which includes an energy recovery sustain circuit incorporating X and Y electrodes. This circuit comprises a load capacitor, first and fourth switching elements to charge the load capacitor up to a predetermined positive voltage, second and third switching elements to charge the load capacitor up to a predetermined negative voltage, a fifth switching element to apply an external voltage to the load capacitor to continually sustain the predetermined positive or negative voltage in the load capacitor during a certain period, an inductor for generating the certain positive or negative voltage to charge the load capacitor, and first and second capacitors for charging or discharging a current flowing through the inductor. This topology provides a complete circuit for all phases. However, it is difficult to decouple the voltage of the half bridges close to the panel. Further, there is at least one MOSFET additionally in series with the voltage supply and the panel during the plasma discharges of the sustain phase.

US 2002/0033806 A1 proposes an energy recovery in a driver circuit for a flat panel display, where a full-bridge driver circuit comprising four controllable switches supplies a voltage having alternating polarities between a first and a second electrode of the flat panel display, wherein a series arrangement of a capacitance present between the first and the second electrode, an inductor, and a diode is arranged in parallel with one of the switches. The diode is poled to be conductive during a resonance phase wherein the control circuit closes one of the switches so that the inductor and the capacitance form a resonant circuit to reverse the polarity of the voltage in an energy-efficient way without requiring any other controllable switches than the ones forming the full-bridge driver circuit. However, as far as EMI is concerned, this concept is less EMI friendly.

However in the prior art topologies certain losses arise. In particular, in the above-mentioned Weber and Ohba topologies the resonant loop between the panel capacitance and the inductor suffers from certain losses; a typically about 80% of the energy is recovered only. After an energy recovery cycle is over, such losses are compensated by adding a voltage step to the recovered panel voltage. However, such an additional voltage step with a very steep slope is not considered to be very beneficial for EMI.

### SUMMARY OF THE INVENTION

So, it is an object of the present invention to provide a more EMI-friendly energy recovery sustain topology. The invention is defined by the independent claims. The dependent claims define advantageous embodiments.

According to the teachings of the present invention, energy recovering storing means are pre-charged before the corresponding energy recovery period wherein the energy recovery storing means is discharged again. By pre-charging of the energy recovery storing means the requirement for the provision of an additional voltage step can be obviated, and, in turn, an improved EMI figure can be reached. In particular, a full voltage swing in recovering the stored energy in the panel capacitance can be achieved.

A further advantage of the topology of the present invention is that fewer switches than in the prior art are required for performing an energy recovery sustain cycle. Consequently, a lower number of switches results in a cheaper constructions of the whole device.

Preferably, the energy recovery storing means comprises an inductor means adapted for forming a resonant circuit with a capacitance of the display panel for creating a resonant cycle during the energy recovery period. Usually, the inductor means is coupled in parallel with the display panel.

The display panel comprises a first terminal means and a second terminal means wherein usually the first terminal means is a common terminal means, and the second terminal means is a scan terminal means.

In a preferred embodiment, the inductor means comprises a first terminal means and a second terminal means, both the first terminal means of the display panel and the inductor means are connectable to a first node, both the second terminal means of the display panel and the inductor means are connectable to a second node, the first node is connected to a first voltage level, and the second node is provided either to be connected to a second voltage level or to ground or to be disconnected from the second voltage level and from ground. The second voltage level should be higher relative to ground than the first voltage level.

Usually the first voltage level is generated by a first voltage source means. This first voltage source means should be connected between the first node and ground.

Moreover, the second voltage level is usually generated by a second voltage source, wherein the second node can be connected to the second voltage source through a first switch which is closed during a sustain period and open during the energy recovery period. Further, the second node can be connected to ground through a second switch which is closed during a sustain period an open during the energy recovery period.

In a further preferred embodiment, during a sustain period either the first switch or the second switch is closed, and during the energy recovery period both the first and second switches are opened. In particular, the closing of the first and the second switch should be done in an alternating manner so as to generate a full voltage swing in the energy recovery period. Namely, in doing so, in a first sustain period the first switch is closed and the second switch is opened, in a subsequent first energy recovery period both the first and second switches are opened, in a subsequent second sustain period, the first switch is opened and the second switches is closed, and in a subsequent second energy recovery period both the first and second switches are opened again, wherein the order consisting of the first sustain period, the first energy recovery period, the second sustain period and the second energy recovery period is repeated.

Inverting the panel voltage with a full voltage swing is advantageous for the first and second switches in particular in case such switches consists of MOSFETs. Namely, when such a switch is activated (closed) its drain-source voltage is zero. With no voltage present over such a switch when activated, its losses are greatly reduced. This in turn is beneficial for power dissipation, EMI and energy recovery efficiency.

In a still further preferred embodiment, the second voltage source comprises a higher potential terminal and a lower potential terminal, the higher potential terminal being connected to the second switch and the lower potential terminal being connected to the first node. So, the first and second voltage sources are coupled in a cascade. This leads to the advantage that the second voltage source does not need to generate the full voltage level relative to ground, but only the difference between the first voltage level and the second voltage level resulting in a simpler construction.

### BRIEF DESCRIPTION OF THE DRAWINGS

In the following, the present invention will be described in greater detail based on preferred embodiments with the reference to the accompanying drawings, in which:

FIG. 1 schematically shows a basic circuit diagram of the conventional Weber topology;

FIGS. 2a to 2d show the different operational modes of the topology of FIG. 1 and FIG. 2e shows the corresponding wave forms of the panel and recovery currents and the panel voltage when inverting the voltage of the display panel;

FIG. 3 schematically shows a basic circuit diagram of the conventional Ohba topology;

FIGS. 4a to 4c show the different operational modes of the topology of FIG. 3 and FIG. 4d shows the corresponding wave forms of the panel and recovery currents and the panel voltage when inverting the voltage of the display panel;

FIG. 5 schematically shows a basic circuit diagram of a topology according to first preferred embodiment of the present invention;

FIGS. 6a to 6d show the different operational modes of the topology according to the first preferred embodiment of the present invention and FIG. 6e shows the corresponding wave forms of the panel and recovery currents and the panel voltage when inverting the voltage of the display panel;

FIG. 7 another graph showing the current and voltage wave forms in the circuit of FIG. 5;

FIGS. 8a and 8b schematically show a basic circuit diagram of a topology according to a second preferred embodiment of the present invention in different operational modes when erasing the display panel;

FIG. 9 schematically shows the basic circuit diagram of the topology according to the second embodiment of the present invention when addressing the display panel;

FIGS. 10a to 10c schematically show the basic circuit diagram of the topology according to the second embodiment of the present invention in three operational modes and FIG. 10d shows the corresponding wave forms of the panel and recovery currents and the panel voltage during the first half of a sustain period; and

FIGS. 11a to 11c schematically shows the basic circuit diagram of the topology according to the second embodiment of the present invention in three operational modes and the corresponding wave forms of the panel and recovery currents and FIG. 11d shows the panel voltage during the second half of a sustain period.

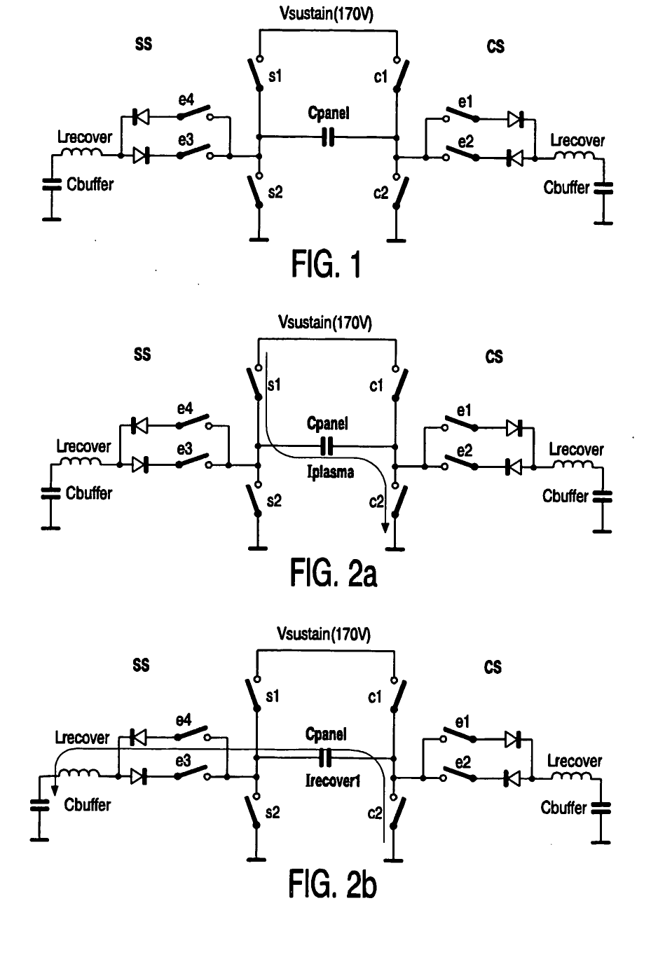

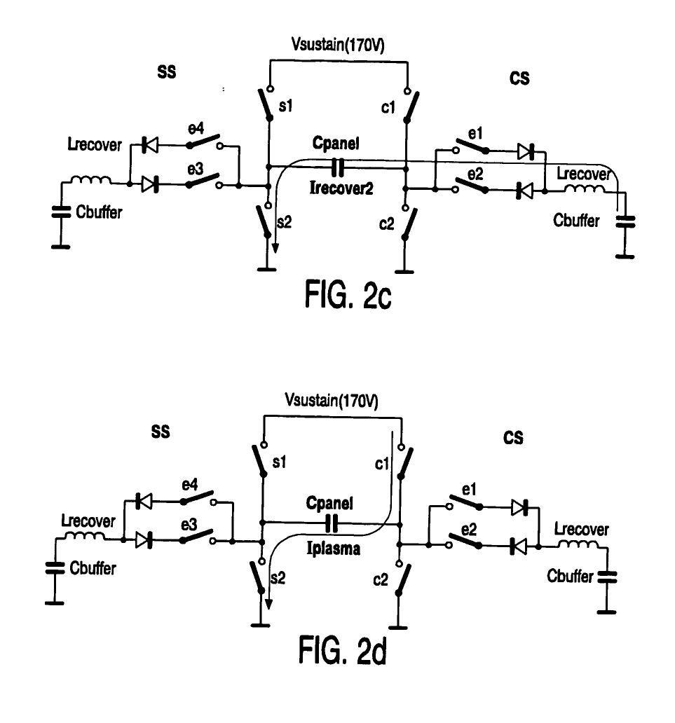

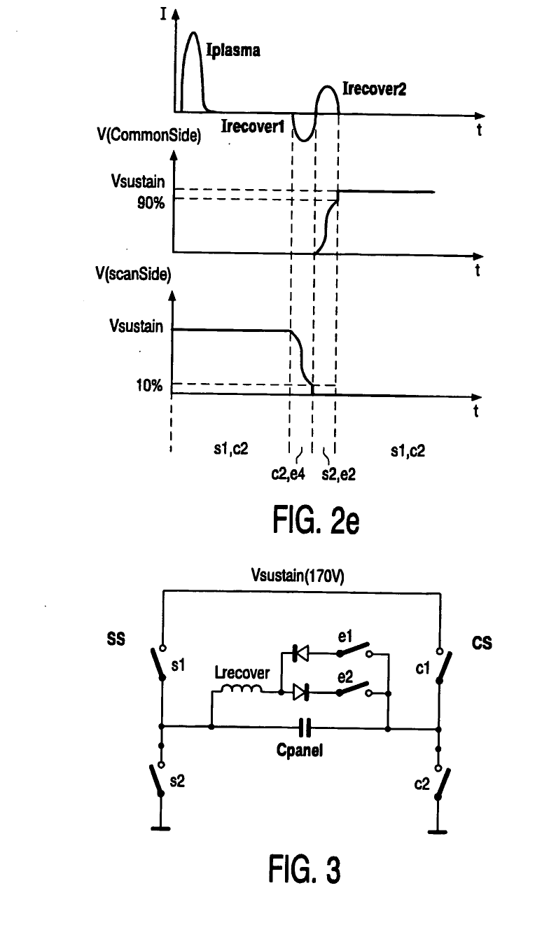

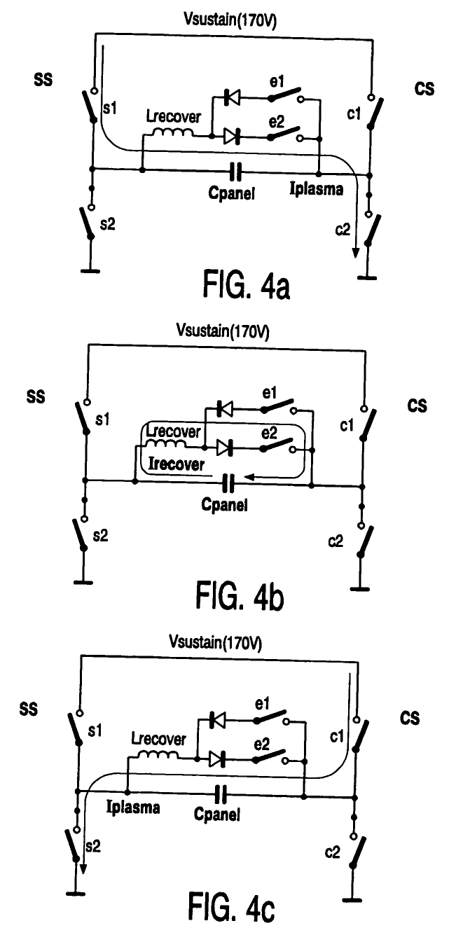

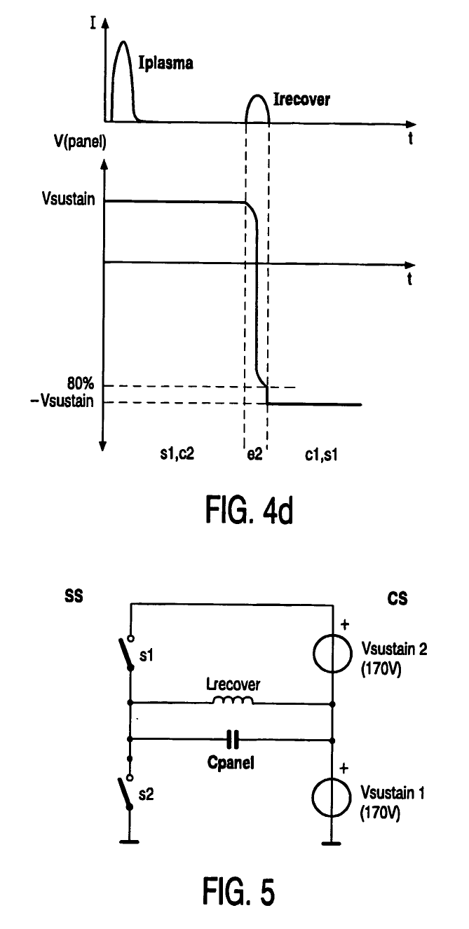

### DESCRIPTION OF PREFERRED EMBODIMENTS

FIG. 5 schematically shows a basic circuit diagram of a topology according to a first preferred embodiment. Instead of a full-bridge driver construction, a half driver construction is implemented in the energy recovery sustain topology shown in FIG. 5. As a consequence of this, the supply voltage for the driver has to be doubled. In the embodiment of FIG. 5, two 170V sustain voltage supplies are stacked, by which the common side of the panel is connected in the middle of the two supplies. Accordingly, the switches used have to withstand twice the sustain voltage, thus 340V.

A resonant path is formed by an inductor L_{recover} connected in parallel with the display panel. In this topology, the inductor L_{recover} is placed in parallel with the panel capacitance Cₚₐₙₑₗ without the use of any extra switches. As shown in FIG. 5, at the common side the first terminals of the display panel (depicted as its capacitance Cₚₐₙₑₗ only) and of the energy recovery inductor L_{recover} are connected together forming a first note which is connected to the higher potential terminal of a first voltage source whereas the lower potential terminal of this first voltage source is connected to ground. Further, at the scan-side the second terminals of the display panel and the energy recovery inductor L_{recover} are connected together forming a second note which is coupled via switch s₁ to the higher potential terminal of a second voltage source and via switch s₂ to ground. The lower potential terminal of the second voltage source is connected to the first note. So, both voltage sources are coupled in series, wherein each of both voltage sources generates a sustain voltage Vₛᵤₛₜₐᵢₙ. In the embodiment of FIG. 5, the sustain voltage generated by each of the voltage sources is 170V.

With only the two switches s₁ and s₂, it will be shown that a PDP can be sustained with recovering energy according to the new topology. Furthermore, it will be shown that no more steep voltage steps are present to compensate for the losses in the resonant path.

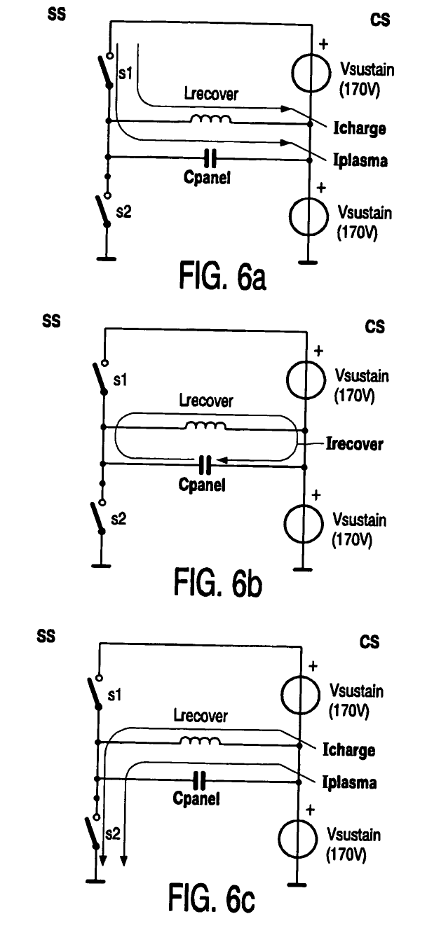

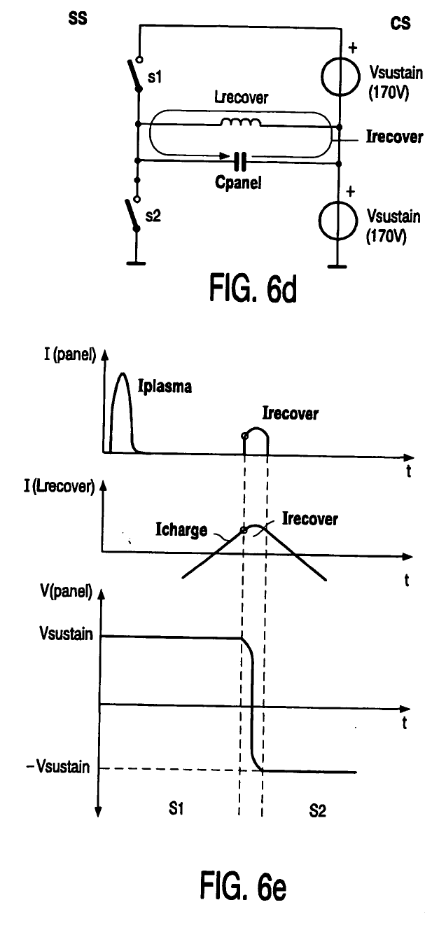

FIGS. 6a to 6d schematically show four different operational modes of the circuit of FIG. 5, and FIG. 6e shows the corresponding wave forms of the panel and recovery currents and the panel voltage.

In FIG. 6a, switch s₁ is activated, i.e. closed. The scan side SS of the display panel is pulled to a voltage which is twice the sustain voltage, i.e. 340V, while the common side CS of the display panel is held at a voltage corresponding to a single sustain voltage, i.e. 170V. Driving the panel with a 170V sustain voltage, plasma cells ignite and a light pulse is emitted. Both the panel voltage and the corresponding peak in the plasma current are shown in FIG. 6e. As long as plasma current is flowing (typically about 1.25 μs) switch s₁ remains activated. Simultaneously in driving the panel with 170V, also the energy recovery inductor L_{recover} is driven with 170V. Because of this, the current through the inductor will linearly increase (V_{L}=L·di/dt)

Releasing i.e. opening the switch s₁, the panel capacitance with L_{recover} now forms a resonant path. Because of the charged inductor at the start of the energy recovery cycle, the current is not sine-wave shaped. The current through the inductor L_{recover} (and panel capacitance Cₚₐₙₑₗ) “bends” to a maximum and decrease again. As in all resonant paths, also here certain losses in recovering energy are present. However, because of the linear increase in the current through L_{recover}, a certain amount of energy is present in this inductor. It is possible to store an equal amount of energy in L_{recover} as the losses in the resonant path are. In doing so, the panel voltage reaches a full swing of 170V. Recovering energy accordingly to this new topology is shown in FIG. 6b, with the flowing currents and panel voltage shown in FIG. 6e.

When the energy recovery cycle is completed (cf. FIG. 6c), switch s₂ is activated (closed) for about 1.25 μs. Hereby the scan side of the panel is pulled to ground, while the common side remains at 170V. Appropriate plasma cells ignite, and again the current through L_{recover} linearly increases. Switch s₂ is released (opened), and energy is recovered the other way around. Inverting the panel voltage back again is shown in FIG. 6d. With this, a full sustain period with this energy recovery sustain topology is completed.

As described above, a full voltage swing is reached in recovering energy. This in turn is beneficial for the sustain switches s₁ and s₂. Switch s₁ respectively s₂ is activated when its drain-source voltage is zero. In doing so, the ‘switch losses’ are greatly reduced and also the power dissipation is less. Furthermore, the EMI figure of the PDP and driver is better.

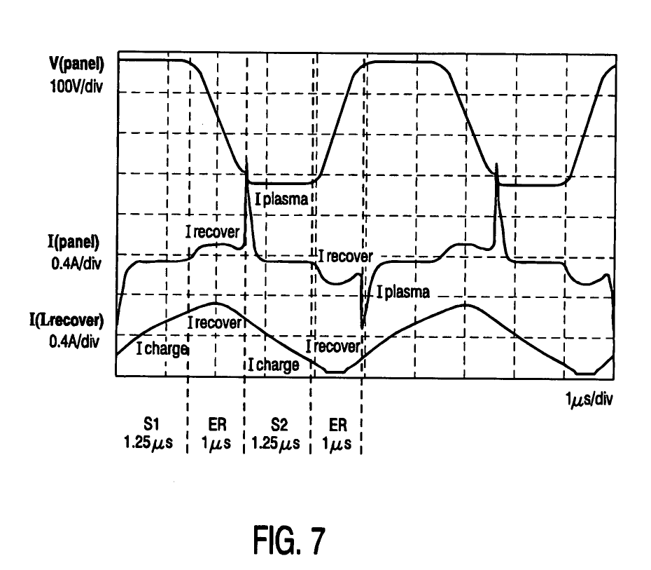

An oscilloscope picture of the PDP drive voltage and flowing currents in the circuit of FIG. 5 is shown in FIG. 7. At t=0, switch s₁ is activated. The current flowing through L_{recover} increases in a linear way, just as intended. For 1.25 μs switch s₁ remains activated, after which the inductor is charged to a proper level. De-activating switch s₁ starts the energy recovery cycle ER. In 1 μs the panel voltage is inverted, which corresponds with the resonance frequency of 0.5 MHz between L_{recover} and Cₚₐₙₑₗ. The panel voltage reaches zero, and switch s₂ is activated to clamp the PDP between Vsus and ground. Plasma cells ignite and a current peak of about 1A (corresponding with a light pulse) is measured. At the same time, the inductor is charged to a proper current level for the coming energy recovery cycle. After 1.25 μs, switch s₂ is de-activated and energy is recovered the other way around. With this, one full sustain period has completed.

With an energy recovery time set at 1 μs, the appropriate switch (s₁ respectively s₂) is activated prior to ignition of plasma cells. With this, the plasma current is drawn from the supplies and not from the resonant circuitry. While keeping switches s₁ and s₂ respectively activated (closed) for 1.25 μs, just enough energy is charged in the inductor to compensate for the losses in the energy recovery cycle. With this, a full voltage swing over the panel is reached. One full sustain period lasts for 4.5 μs, which corresponds with a frequency of 220 kHz. Also this frequency seems appropriate to sustain a PDP.

In the embodiment of FIG. 5, the energy recovery inductor is connected directly in parallel with the panel. In the erase phase, the scan side SS is driven at 340V, and the common side CS is grounded. For about 12 μs, the PDP is driven in this way. After that, both sides of the PDP are grounded which completes the erase phase. With the recovery inductor L_{recover} directly in parallel with the panel capacitance Cₚₐₙₑₗ, it should also be driven in this erase phase. In 12 μs the current flowing through the inductor might increase too high. For the addressing phase, a similar deduction can be made. To address a PDP, at the common side CS of the PDP (e.g. in FIG. 5 at the right hand side) all rows are connected together and driven at typically 60 V. In a simple addressing scheme, the PDP is addressed one row after another each at a time, i.e. row 1, row 2, row 3, row 4 and so on. The row to be addressed is driven at the scan side SS (e.g. in FIG. 5 at the left hand side) at typically −160 V, whereas the other rows are held at typically −60 V. Such voltage levels (i.e. 60 V at the common side and −60 V respectively −160 V at the scan side) correspond with proper address levels for PDPs now on the market. To address all the rows in a PDP during an addressing phase takes about 1 ms. Because of this relatively long addressing time, the inductor should be disconnected during that time.

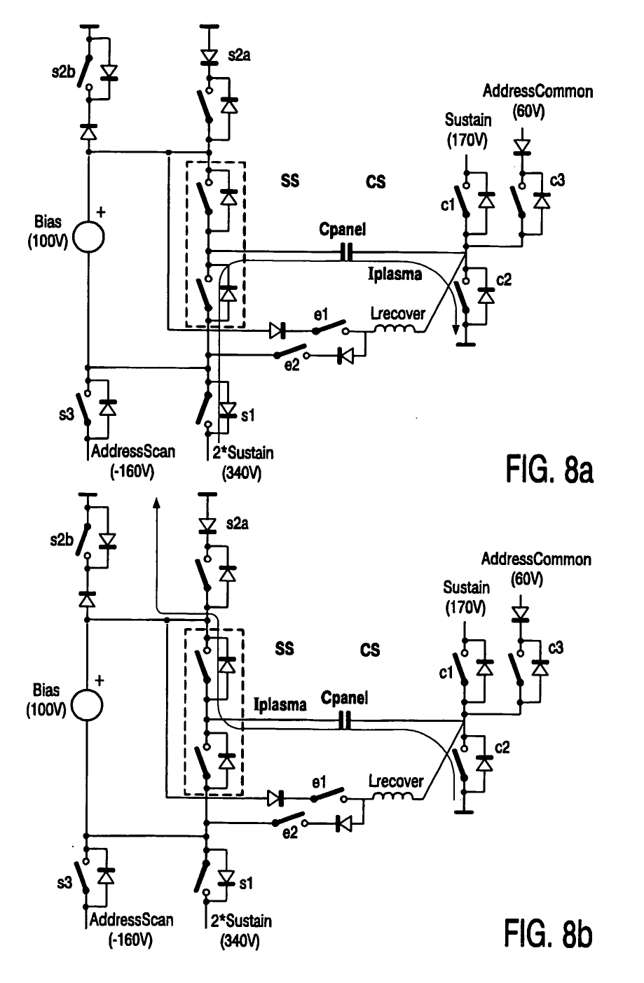

So, to avoid driving the inductor in both the erase and address phase, extra switches can be provided by which the inductor can be disconnected from the PDP. FIG. 8 schematically shows a basic circuit diagram of a topology according to a second preferred embodiment wherein the energy recovery inductor L_{recover} is connected via switches e₁ and e₂ in parallel with the display panel and, thus, its panel capacitance Cₚₐₙₑₗ. As seen from FIG. 8, the switches e₁ and e₂ are provided in series with the energy recovery inductor L_{recover}.

In erasing the PDP, use is made of switch s₁. Being connected at a voltage source of twice the sustain voltage (340V), it is high enough to properly erase the PDP. Activating switch s₁ both for sustaining and erasing the PDP, a separate switch for erasing is saved. In FIG. 8a is shown how the PDP is erased with a 340V pulse. Subsequently in FIG. 8b, both sides of the PDP are grounded which completes the erase phase.

From FIG. 8 showing the erase phase it is clearly seen that the current tending to flow through the energy recovery inductor is blocked. After erasing the PDP, both sides are grounded by activating switches s₂ₐ, s_{2b} and c₂. According to the direction of the current in FIG. 8b, it should be sufficient to activate only switches s_{2b} and c₂.

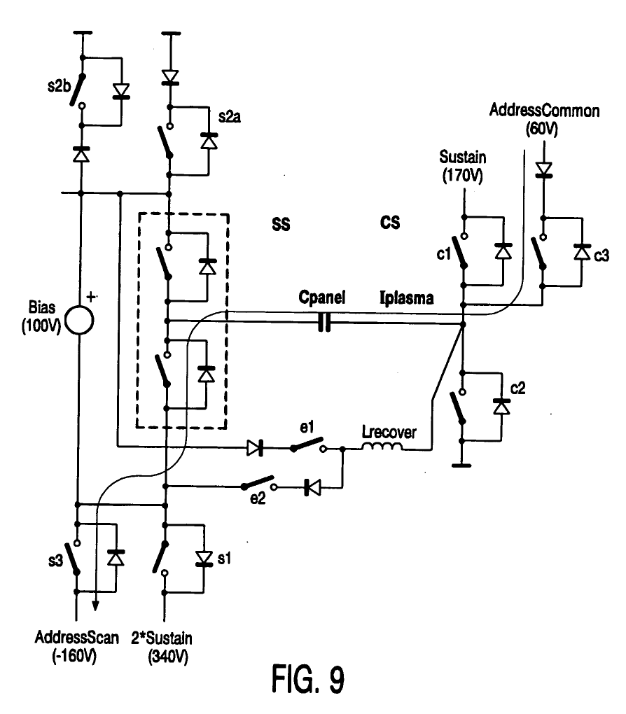

In addressing the PDP, the common side is driven positively (60V), and the scan side is driven negatively (from −60V to −160V). Again the current through the inductor is blocked, and only the PDP is driven accordingly to address the PDP as shown in FIG. 9. When all rows are scanned and consequently the proper cells are addressed, both sides of the PDP are grounded in the same way as shown in FIG. 8b.

In the circuit explained in conjunction with the FIGS. 5 to 7, the PDP and the inductor were driven simultaneously in the sustain phase. A time of 1.25 μs is sufficient for charging the inductor L_{recover} with just enough energy to reach a full voltage swing once energy was recovered. In more conventional driving schemes, a PDP is sustained for about 2 μs. Instead of driving the inductor simultaneously with the PDP, it might be beneficial to drive the inductor at a later time. In properly timing the switches e₁ and e₂, it is possible to sustain the PDP for 2 μs and drive the inductor for 1.25 μs.

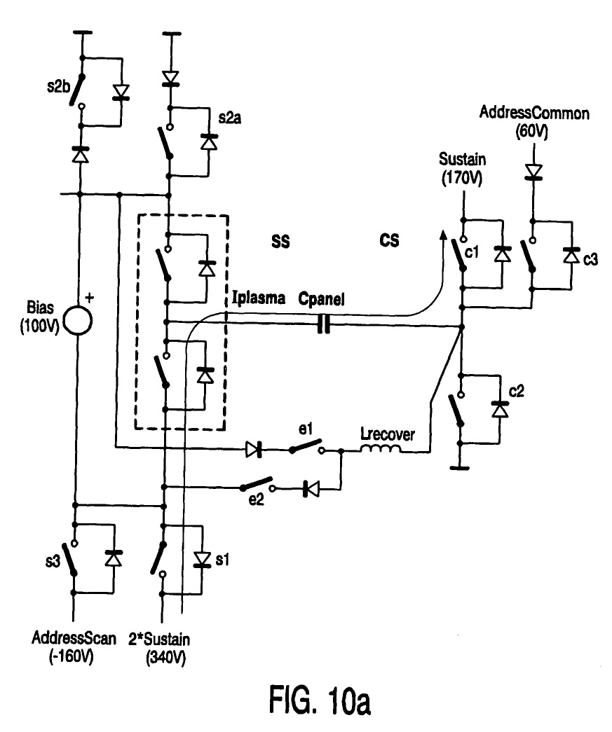

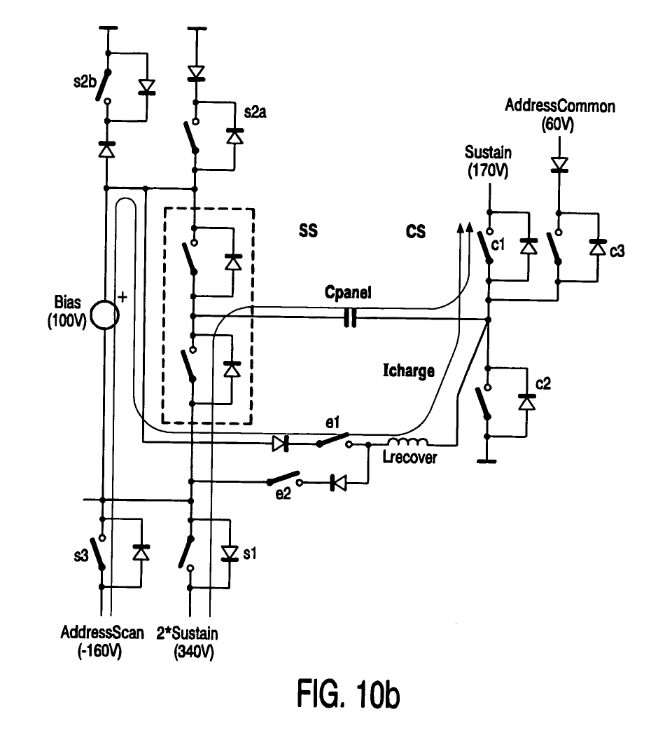

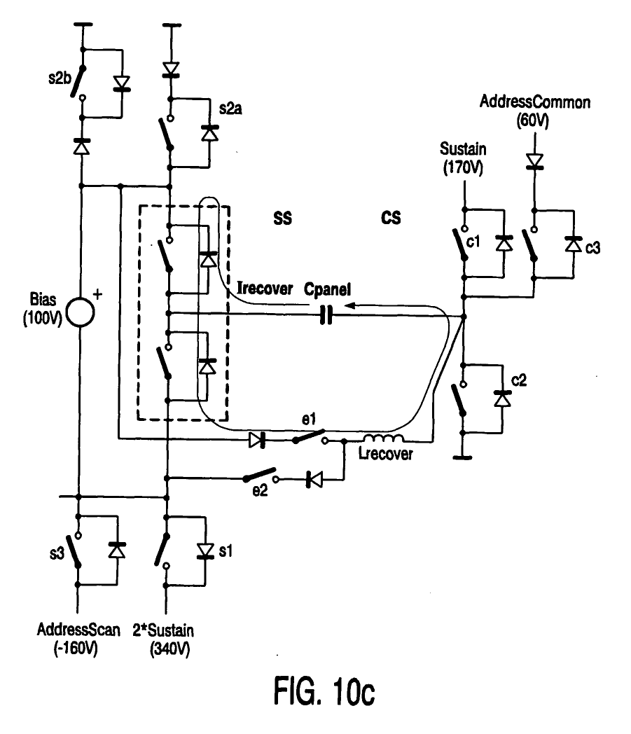

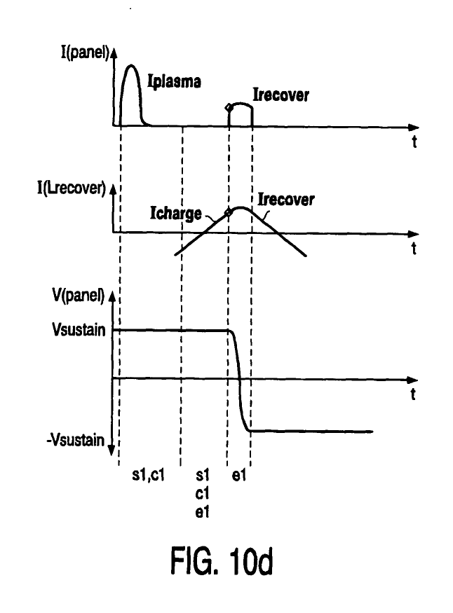

FIGS. 10a to 10c schematically show the basic circuit diagram of the topology according to the second embodiment in three operational modes, and FIG. 10d shows the corresponding wave forms of the panel and recovery currents and the panel voltage a during the first half of a sustain period.

In FIG. 10a, the scan side of the PDP is sustained while the inductor remains disconnected. Driving the PDP with 170V causes plasma cells to ignite, and consequently a current peak flows through the panel. The corresponding peak in the plasma current is shown in FIG. 10d.

At a given time, switch e₁ is activated to charge the energy recovery inductor with a proper current (FIG. 10b). Because of the voltage supply in parallel with a scan integrated circuit (scan-IC) the inductor is driven with 270V (=340V−100V−170V). The current through the inductor L_{recover} increases in the linear way as shown in FIG. 10d. When the correct value increases so as to reach a full voltage swing in energy recovery, switches s₁ and c₁ are de-activated. So, the stored energy in the panel capacitance Cₚₐₙₑₗ is recovered, with the panel currents and the panel voltages as shown in FIG. 10d. At this point in time, halve a sustain period is completed, and the PDP will be sustained the other way around.

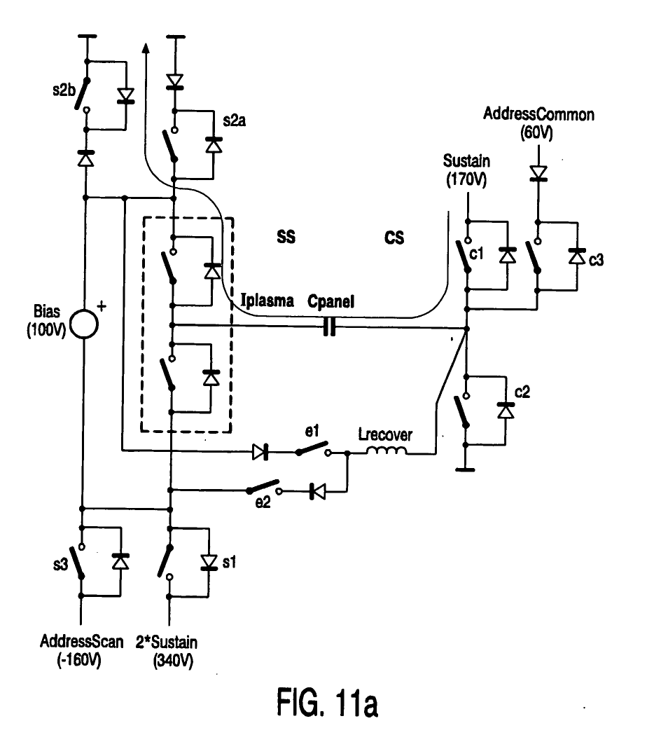

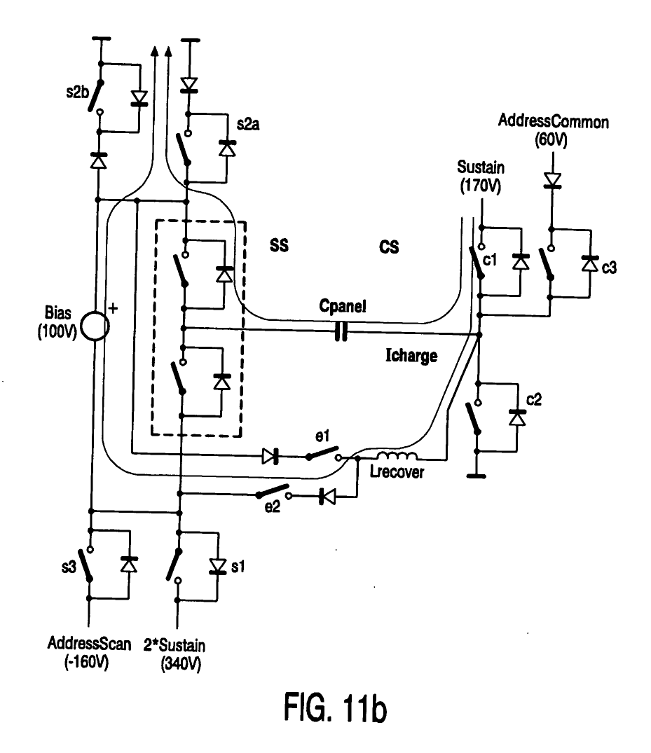

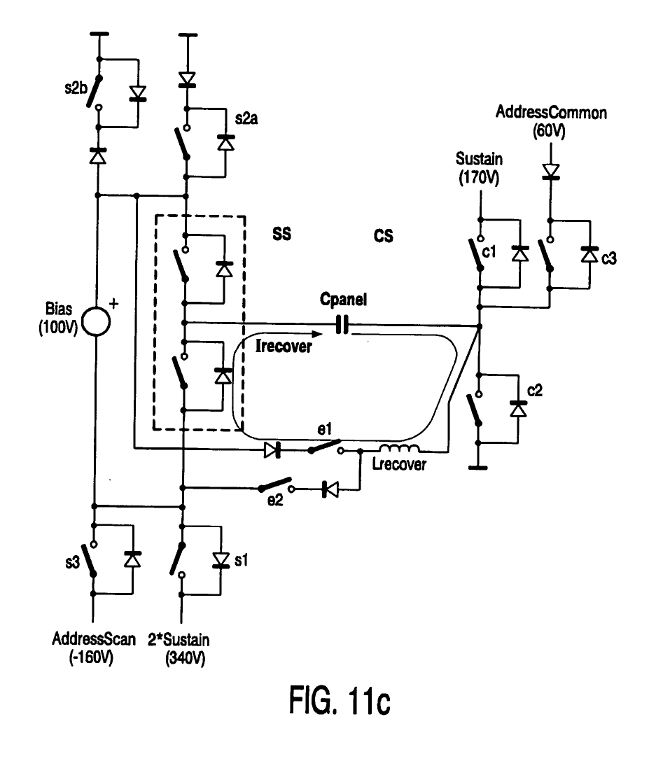

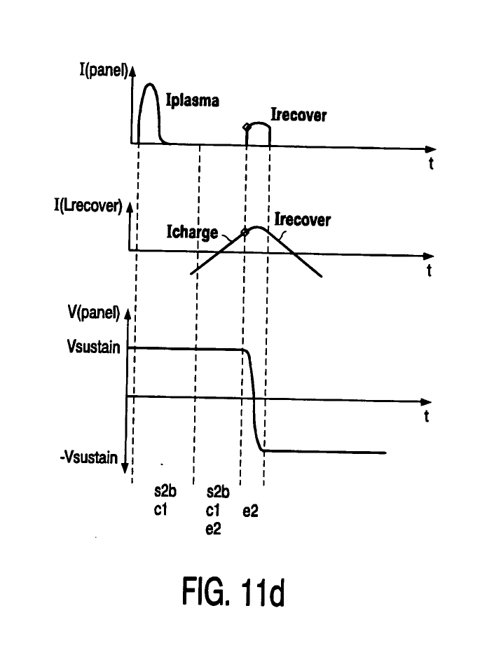

Prior to the ignition of the addressed plasma cells, switches s_{2b} and c₁ have to be activated (closed). So, the common side is driven with a 170V sustain voltage (FIG. 11a). The corresponding plasma current flowing through the panel is shown in FIG. 11d. Likewise as is done in the first halve of a sustain period, the energy recovery inductor L_{recover} is charged at a proper time. Now switch e₂ is activated (closed) (FIG. 11b), and the inductor current increases linearly. Again the 100V supply for the scan-IC is set in series with the drive voltage for the inductor. Hereby the inductor L_{recover} is driven with 270V (170V+100V). After the correct charge current in the inductor L_{recover} has been reached, both switches s_{2b} and c₁ are de-activated. Energy is recovered, and again a full swing in the panel voltage is achieved by the charged energy recovery inductor L_{recover}. In FIG. 11c, the sustain period has ended, and the complete sequence may start again with the operational mode shown in FIG. 10a.

In the case of sustaining and recovering energy in a PDP, large currents are involved. Back gate diodes in the scan-IC are capable of handling more current than its accompanying MOS-transistors. For this reason it is beneficial if the scan-IC can be set in a ‘tri-state’ mode. In all discussed phases of a sustain period, the switches in the scan-IC remain in their tri-state mode, and the current is conducted by the back-gate diodes.

Although the invention has been described above with reference to examples shown in the attached drawings, it is apparent that the invention is not restricted to them, but can vary in many ways within the scope disclosed in the attached claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. An energy recovery sustain device for a display panel, in particular a plasma display panel, comprising
energy recovery storing means (L_{recover}) adapted for coupling with the display panel for performing an energy recovery period following a sustain period, and
means for charging said energy recovery storing means (L_{recover}) in said sustain period.

2. The device according to claim 1, wherein said energy recovery storing means comprises inductor means (L_{recover}) for forming a resonant circuit with the capacitance (Cₚₐₙₑₗ) of the display panel to create a resonant cycle during said energy recovery period.

3. The device according to claim 2, wherein said inductor means (L_{recover}) are provided to be coupled in parallel with the display panel.

4. The device according to claim 3, wherein the display panel comprises first display terminal means and second display terminal means, and said inductor means (L_{recover}) comprise first inductor terminal means and second inductor terminal means, wherein both said first display terminal means and said first inductor terminal means are connectable to a first node, both said second display terminal means and said second inductor terminal means are connectable to a second node, said first node is connected to a first voltage level, and said second node is provided either to be connected to a second voltage level or to ground or to be disconnected from said second voltage level and from ground.

5. The device according to claim 4, wherein the first display terminal means are common terminal means, and the second display terminal means are scan terminal means.

6. The device according to claim 4, wherein said second voltage level is higher relative to ground than said first voltage level.

7. The device according to claim 4, wherein said first voltage level is generated by a first voltage source means connected between said first node and ground.

8. The device according to claim 4, wherein said second voltage level is generated by a second voltage source, and said second node is connected to said second voltage source through a first switch (s₁) which is closed during a sustain period and open during the energy recovery period.

9. The device according to claim 8, wherein said second node is connected to ground through a second switch (s₂) which is closed during a sustain period and open during the energy recovery period.

10. The device according to claim 9, wherein during a sustain period either said first switch (s₁) or said second switch (s₂) is closed, and during the energy recovery period both said first and second switches are open.

11. The device according to claim 10, wherein
in a first sustain period said first switch (s₁) is closed and said second switch (s₂) is open,
in a subsequent first energy recovery period both said first and second switches (s₁, s₂) are open,
in a subsequent second sustain period said first switch (s₁) is open and said second switch (s₂) is closed, and
in a subsequent second energy recovery period both said first and second switches (s₁, s₂) are open,
wherein the order consisting of said first sustain period, said first energy recovery period, said second sustain period and second energy recovery period is repeated.

12. The device according to claim 9, wherein said second voltage source comprises a higher potential terminal and a lower potential terminal, said higher potential terminal being connected to said second switch and said lower potential terminal being connected to said first node.

13. A driving apparatus for driving a display panel, in particular a plasma display panel, comprising an energy recovery sustain device according to claim 1.

14. A display apparatus for displaying an image, comprising a display panel, in particular a plasma display panel, and an energy recovery sustain device according to claim 1.
